(19) United States
(12) Patent Application Publication
(10) Pub. No.: US 2021/0140417 A1
(43) Pub. Date: May 13, 2021

(54) MOTOR ARRANGEMENT AND PRESSURE WASHER WITH SUCH MOTOR ARRANGEMENT

(71) Applicant: TTI (MACAO COMMERCIAL OFFSHORE) LIMITED, Grande, Macao (CN)

(72) Inventors: Sven Eschrich, Guangdong (CN); Chin Hung Ricky Lam, Hong Kong (CN)

(21) Appl. No.: 16/629,789

(22) PCT Filed: Jul. 12, 2017
(86) PCT No.: PCT/CN2017/092613

§ 371 Date: Jan. 9, 2020

(51) Int. Cl. F04B 17/03; B08B 3/02; F04B 19/04; H02K 7/116; H02K 7/108

(52) U.S. Cl. CPC F04B 17/03; B08B 3/026; H02K 7/108; H02K 7/116; F04B 19/04

(57) ABSTRACT

A motor arrangement (10) is disclosed as including an AC motor (12) with an output, a DC motor (14) with an output, a power transmission mechanism (18) including a first one-way clutch (20) and a second one-way clutch (22), the power transmission mechanism being coupled with the output of the AC motor via the first one-way clutch and coupled with the output of the DC motor via the second one-way clutch.

This invention relates to a motor arrangement and a pressure washer with such a motor arrangement.

In existing motorized pressure washers, usually a long stack hybrid motor is used for operating a high-pressure pump to pressurize the water in the pressure washers. However, if such a motor breaks down during use, the pressure washer cannot operate until the motor is repaired, which delays the work on hand.

It is thus an object of the present invention to provide a motor arrangement and a pressure washer with such a motor arrangement in which the aforesaid shortcoming is mitigated, or at least to provide a useful alternative to the public.

According to a first aspect of the present invention, there is provided a motor arrangement including at least one AC motor with an output, at least one DC motor with an output, a power transmission mechanism including a first coupling member and a second coupling member, wherein said power transmission mechanism is coupled with said output of said AC motor via said first coupling member and is coupled with said output of said DC motor via said second coupling member.

According to a second aspect of the present invention, there is provided a motorized pressure washer including a motor arrangement including at least one AC motor with an output, at least one DC motor with an output, a power transmission mechanism including a first coupling member and a second coupling member, wherein said power transmission mechanism is coupled with said output of said AC motor via said first coupling member and is coupled with said output of said DC motor via said second coupling member, and a pump coupled to an output of said power transmission mechanism of said motor arrangement and drivenable by said motor arrangement.

A motor arrangement according to an embodiment of the present invention will now be described, by way of an example only, with reference to the following drawings, in which:

FIG. 1 is a perspective view of a motor arrangement according to an embodiment of the present invention;

FIG. 2 is a schematic sectional view of a part of the motor arrangement of FIG. 1; and

FIG. 3 is a schematic view of a part of the motor arrangement of FIG. 1.

FIG. 1 shows a perspective view of a motor arrangement according to an embodiment of the present invention, generally designated as 10. The motor arrangement 10 includes an AC motor 12 and a DC motor 14 which are coupled with a working member, such as a high-pressure pump 16, via a power transmission mechanism 18. The AC motor 12 and the DC motor 14 are arranged in parallel with each other.

As shown in more detail in FIG. 2, the power transmission mechanism 18 includes two one-way clutches 20, 22. The one-way clutch 20 is coupled with and located between a pinion 24 and an output shaft 26 of the AC motor 12; and the one-way clutch 22 is coupled with and located between a pinion 28 and an output shaft 30 of the DC motor 14. Both the one-way clutches 20, 22 are in mesh with a central gear 32 for operating the high-pressure pump 16. At any time, only one of the AC motor 12 and DC motor 14 operates. When the AC motor 12 operates, the pinion 24 rotates and brings about corresponding rotation of the one-way clutch 20, which in turn brings about rotation of the central gear 32 of the pump 16, to operate the pump 16 to pressurize the water in a pressure washer. When the DC motor 14 operates, the pinion 28 rotates and brings about corresponding rotation of the one-way clutch 22, which in turn brings about rotation of the central gear 32 of the pump 16, to operate the pump 16 to pressurize the water in a pressure washer.

As shown in FIG. 3, the one-way clutches 20, 22 may be roller-type one-way clutches each with an outer ring (not shown), a plurality of rollers 34 which allow the one-way clutches 20, 22 to rotate in one direction, and an inner ring 36 with a plurality of indentations 38 on its inner surface which trap the rollers 34, thus preventing the clutches 20, 22 to rotate in an opposite direction.

Thus, by way of the above arrangement, when the AC motor 12 is operated (ON), the output shaft 26 of the AC motor 12 rotates and drives, via the one-way clutch 20, the pinion 24 to rotate, which in turn brings about rotational movement of the central gear 32. When the AC motor 12 is thus operated, the DC motor 14 is OFF and its output shaft 30 is also stationary. Although rotation of the central gear 32 will bring about rotational movement of the outer ring of the one-way clutch 22, because of the construction of the one-way clutch 22, such will not bring about corresponding movement of the inner ring 36 of the one-way clutch 22, and thus it will not bring about rotational movement of the output shaft 30 of the DC motor 14. Thus, no energy from the AC motor 12 is wasted on driving the DC motor 14.

Similarly, when the DC motor 14 is operated (ON), the output shaft 30 of the DC motor 14 rotates and drives, via the one-way clutch 22, the pinion 28 to rotate, which in turn brings about rotational movement of the central gear 32. When the DC motor 14 is thus operated, the AC motor 12 is OFF and its output shaft 26 is also stationary. Although rotation of the central gear 32 will bring about rotational movement of the outer ring of the one-way clutch 20, because of the construction of the one-way clutch 20, such will not bring about corresponding movement of the inner ring 36 of the one-way clutch 20, and thus it will not bring about rotational movement of the output shaft 26 of the AC motor 12. Thus, no energy from the DC motor 14 is wasted on driving the AC motor 12.

It should be understood that the above only illustrates an example whereby the present invention may be carried out, and that various modifications and/or alterations may be made thereto without departing from the spirit of the invention.

It should also be understood that various features of the invention which are, for brevity, described in the context of a single embodiment, may also be provided separately or in any appropriate sub-combinations.

1. A motor arrangement including:
at least one AC motor with an output,
at least one DC motor with an output,
a power transmission mechanism including a first coupling member and a second coupling member,
wherein said power transmission mechanism is coupled with said output of said AC motor via said first coupling member and is coupled with said output of said DC motor via said second coupling member.

2. A motor arrangement according to claim 1 wherein said power transmission mechanism includes an output which is adapted to be coupled to a working member.

3. A motor arrangement according to claim 1 wherein said first coupling member is a first one-way clutch.

4. A motor arrangement according to claim 1 wherein said second coupling member is a second one-way clutch.

5. A motor arrangement according to claim 3 wherein said first one-way clutch is a roller-type one-way clutch.

6. A motor arrangement according to claim 5 wherein said roller-type one-way clutch includes an outer ring, a plurality of rollers, and an inner ring with a plurality of indentations on its inner surface.

7. A motorized pressure washer including:
a motor arrangement according to claim 1, and
a pump coupled to an output of said power transmission mechanism of said motor arrangement and drivenable by said motor arrangement.
